(19) United States
(12) Patent Application Publication
(10) Pub. No.: US 2024/0327580 A1
(43) Pub. Date: Oct. 3, 2024

(54) LIGNIN FRACTIONATION

(71) Applicants: Katholieke Universiteit Leuven, Leuven (BE); Klabin S.A., São Paulo (BR)

(72) Inventors: Pedro FARDIM, Holsbeek (BE); Rita CAIADO GASPAR, Leuven (BE); Marcelo COELHO DOS SANTOS MUGUET SOARES, Telêmaco Borba (BR); Bruno BRISOLLA RAVANELLO, Telêmaco Borba (BR); Allan FRANSISCO HORCHULHAK, Telêmaco Borba (BR)

(21) Appl. No.: 18/577,154

(22) PCT Filed: Jul. 7, 2022
(86) PCT No.: PCT/EP2022/068997

§ 371 Date: Jan. 5, 2024

(30) Foreign Application Priority Data
Jul. 7, 2021 (EP) 21184161.4

(51) Int. Cl. C08H 7/00

(52) U.S. Cl. CPC C08H 6/00

(57) ABSTRACT

The invention relates to a method of isolating a lignin fraction from a solution comprising solubilised lignin, the method comprising the steps of adding water to a solution comprising solubilised lignin and a hydrotrope, thereby lowering the hydrotrope concentration, until a part of the lignin becomes insoluble, and isolating the insoluble lignin.

### FIELD OF THE INVENTION

The invention relates to the fractionation of lignin using hydrotropes

### BACKGROUND OF THE INVENTION

Lignin is the second most abundant biopolymer on earth after cellulose and it is mostly obtained as a by-product of paper and pulp industry and biorefineries.

Lignin potential as a raw material for high-added value applications lies not only in its high availability, biodegradability and biocompatibility but also in its antioxidant and antimicrobial properties. The main drawback in lignin usage as a raw-material is its heterogeneity and high polydispersity. Therefore, fractionation of lignin to retrieve polymer fractions with well-defined molecular weight (Mw) and low dispersity is a very important step to valorise lignin and develop new applications.

The possible applications for different types of lignin include its usage as fuel, the production of fine chemicals such as BTX (Benzene, Toluene and Xylene) and derivatives, vanillin, phenol and organic acids. Additionally, it can also be used as the main or one of the components of cements, foams, resins, adhesives, dispersants and adsorbents. Furthermore, due to its interesting biological properties and biocompatibility it has the potential to be used in biomedical applications such as in drug carrier systems and tissue engineering.

Kraft Lignin, originated from the Kraft Process of pulp industry, is the main lignin source nowadays, with millions of tons being produced annually worldwide. While most of this lignin is burned as fuel, the high availability of this by-product and its interesting properties induced a growth in research for separation and purification of Kraft Lignin from the Black Liquor.

The fractionation of Lignoboost Kraft Lignin research interest is increasing with several research groups throughout the world achieving interesting results in fractionation and possible applications of this fractionated lignin.

So far, two methods can be found in literature for fractionation of Kraft Lignin by either organic solvent fractionation [Jiang et al. (2017) ACS Sustain. Chem. Eng. 5, 835-842] or membrane processes [Sevastyanova et al. (2014) J. Appl. Polym. Sci. (2014) 131, 9505-9515]. The organic solvents fractionation is based on the solubility of lignin fractions with different Mw in specific solvents, such as ethanol, methanol and acetone. Meanwhile, fractionation through membrane separation processes, usually involves the fractionation of Kraft lignin directly from the black liquor or retrieved through a different process than the Lignoboost using ultrafiltration membranes.

Hydrotropes are non-toxic, biodegradable, reusable organic salts that increase the solubility of certain solutes in water and other solvents when added in specific amounts. The principal advantage of using hydrotropes is the possibility of recovering the solute of interest, whenever required by diluting the solution with water, to specific concentrations, making the solute reprecipitate.

In recent years, lignin has been extracted from different species of softwood and hardwood by using a hydrotropic solution under specific conditions, to separate lignin from cellulose and hemicellulose. Afterwards, the lignin is recovered by diluting with water originating lignin precipitation and the hydrotropic solution can be reused for several times before losing its function. The most used hydrotropes for this specific process are sodium xylenesulfonate, p-toluenesulfonic acid and maleic acid.

U.S. Pat. No. 3,490,990 discloses that lignin can be precipitated from a solution with hydrotrope by adding water. Wang et al. (2020) Indust. Crops Prod. 150, 112423 discloses that lignin can be precipitated by diluting p-TSOH to a concentration below 11.5%. Chen et al. (2017) Sci Adv 3 e 1701735) and U.S. Pat. No. 10,239,905 disclose that lignin precipitates from wood poplar biomass from about 16% p-TsOH, whereby further dilution to 4% increased the amount of precipitated lignin.

### SUMMARY OF THE INVENTION

The hydrotropic extraction of lignin shows that by using different reaction temperatures, concentration of hydrotrope and reaction time, it is possible to obtain different lignin fractions with different Mw and properties.

Generally, Lignoboost Kraft Lignin (LKL) is insoluble in water but soluble in hydrotropic solutions. The present invention discloses the use of hydrotropic aqueous solutions to precipitate lignin fractions with specific Mw, lower dispersity and different content of functional groups based on the solubility of lignin fractions in different hydrotropic concentrations. Preferred hydrotropes chosen for this process are Sodium Xylenesulfonate (SXS) and Sodium Cumenesulfonate (SCS).

The final hydrotropic solution can then be reconcentrated by evaporation and reused several times.

The present invention shows that it is possible to fractionate Lignoboost Kraft Lignin (LKL) by diluting hydrotropic solutions of Sodium Xylenesulfonate (SXS) and Sodium Cumenosulfonate (SCS) through the addition of water. The selective precipitation of 100 g/L lignin in SXS solutions occurs when hydrotrope concentrations is equal or below 16 wt % and it is possible to retrieve 4 different fractions for hydrotrope concentrations of 16, 14, 12 and 10 wt %. The molecular weights (Mw) of the different fractions were confirmed by GPC with values between 24 and 7 kDa and a decrease in polydispersity values visible in all fractions.

The fractionation through solutions of SCS produced 3 different fractions for hydrotropic concentrations of 10, 8 and 6 wt %. These fractions have a Mw between 24 and 19 kDa. The fractionation of LKL by using a solution of NaOH was not feasible

The characterization of the fractions as well as the original LKL sample by FTIR-ATR and H-NMR enabled the analysis of the overall structure of LKL and the obtained fractions. Moreover, these two characterization methods allowed the study of the efficiency of the washing process to remove residual hydrotrope from the fractions.

The amount of water to completely wash the fractions from the hydrotrope is around 200 parts in weight of water to 1 part in weight of dry lignin. However, the hydrotropes can be recovered by evaporation and the washing water together with the final hydrotropic solution, can be reutilized.

Additionally, the characterization by quantitative C-NMR results shows that the different fractions have different contents of phenolic and aliphatic OH and β-O-4′ linkages. The fractions with lower hydrotropic % (lower Mw) have higher contents of phenolic OH and lower contents of aliphatic OH. The results of the elemental analysis confirm that there is no significant difference in the sulphur content between the original Lignoboost sample and the different fractions, showing it is possible to remove any residual hydrotrope from the fractions.

Mass balances show that the 16 wt % SXS and the 8 wt % SCS fractions have the highest yield on lignin recovered from the initial solution with approximately 72% and 78% of dissolved lignin being retrieved in these fractions, respectively. Around 10-13% of the original lignin remains dissolved in the final hydrotropic solutions.

The invention is further summarised in the following statements:
1. A method of isolating a lignin fraction from a solution comprising solubilised lignin, the method comprising the steps of:
a) adding water to a solution comprising solubilised lignin and a hydrotrope, thereby lowering the hydrotrope concentration, until a part of the lignin becomes insoluble, and b) isolating the insoluble lignin.
2. The method according to statement 1, wherein steps a) and b) are repeated, for example up to 5 times;
3. The method according to statement 1 or 2, wherein the solubilised lignin is kraft lignin.
4. The method according to any one of statements 1 to 3, wherein the solution comprising solubilised lignin and a hydrotrope has a concentration of between 25, or 50 up to 100 or 120 g lignin/litre.
5. The method according to any one of statements 1 to 4, wherein the solution comprising solubilised lignin and a hydrotrope has a concentration of 30 wt % hydrotrope.
6. The method according to any one of statements 1 to 5, wherein the hydrotrope is SXS or SCS.
7. The method according to any one of statements 1 to 6, wherein the hydrotrope is SXS and wherein the concentration of SXS is stepwise or continuously decreased to down 10 wt % SXS,
8. The method according to any one of statements 1 to 6, wherein the hydrotrope is SCS and wherein the concentration of SCS is decreased stepwise or continuously down to 6 wt % SCS, typically stepwise decreased.
9. The method according to anyone statements 1 to 8, wherein the initial solution comprising solubilised lignin and a hydrotrope is diluted with water to between a threefold and a fivefold.
10. Use of the method according to any one of statements 1 to 9, for enriching from a crude fraction of lignin, a fraction of lignin which is enriched in aliphatic OH content, in phenolic OH content, or in a molecular weight range.
11. Crude fraction of lignin or fraction of lignin enriched by the method according to any one of statements 1 to 9.

### BRIEF DESCRIPTION OF THE FIGURES

FIG. 1. Diagram of experimental procedures.

FIG. 2. Diagram of experimental procedures

FIG. 3. FTIR-ATR spectra of original dry lignin sample.

FIG. 4. FTIR-ATR spectra of the recovered lignin fractions from selective precipitation with sodium xylenesulfonate (SXS).

FIG. 5. FTIR spectra of the recovered lignin fractions from selective precipitation with sodium cumenesulfonate (SCS).

FIG. 6. FTIR-ATR spectra comparison between a fraction of lignin obtained by selective precipitation (16 wt %) and the original lignin.

FIG. 7. FTIR-ATR spectra comparison between a fraction of lignin obtained by selective precipitation (16 wt %) after additional washing and the original lignin.

FIG. 8. H-NMR spectra of pure Lignoboost Lignin, Pure SCS and pure SXS.

FIG. 9. H-NMR of pure lignin, cleaned fraction of 16 wt % SXS and the same fraction with residual hydrotrope

FIG. 10. C-NMR spectra of non-acetylated and acetylated softwood Lignoboost Lignin provided.

FIG. 11. Molecular weight distribution of SXS fractions.

FIG. 12. Molecular weight distribution for the SCS fractions.

FIG. 13. FTIR-ATR spectra comparison between a fraction of lignin obtained by selective precipitation (10 wt %) before and after additional washing and the original lignin.

FIG. 14. FTIR-ATR spectra comparison between a fraction of lignin obtained by selective precipitation (12 wt %) before and after additional washing and the original lignin.

FIG. 15. FTIR-ATR spectra comparison between a fraction of lignin obtained by selective precipitation (14 wt %) before and after additional washing and the original lignin.

FIG. 16. FTIR-ATR spectra of pure hydrotropic powders, SXS and SCS.

FIG. 17. C-NMR spectra of acetylated samples of SXS fractions.

FIG. 18. C-NMR spectra of non-acetylated samples of SXS fractions.

FIG. 19. C-NMR spectra of acetylated samples of SCS fractions.

FIG. 20. C-NMR spectra of non-acetylated samples of SCS fractions.

FIG. 21. C-NMR spectra of pure SCS and pure SXS.

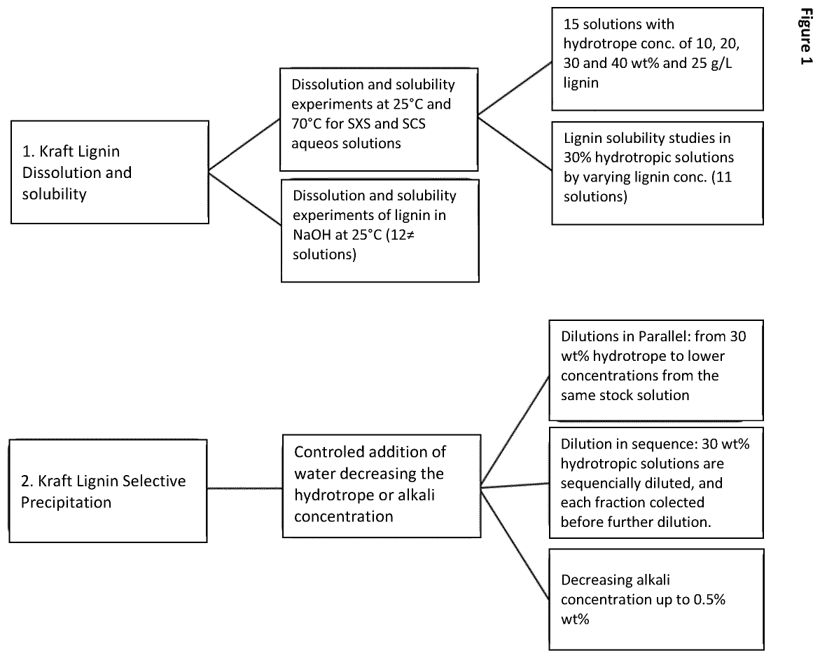

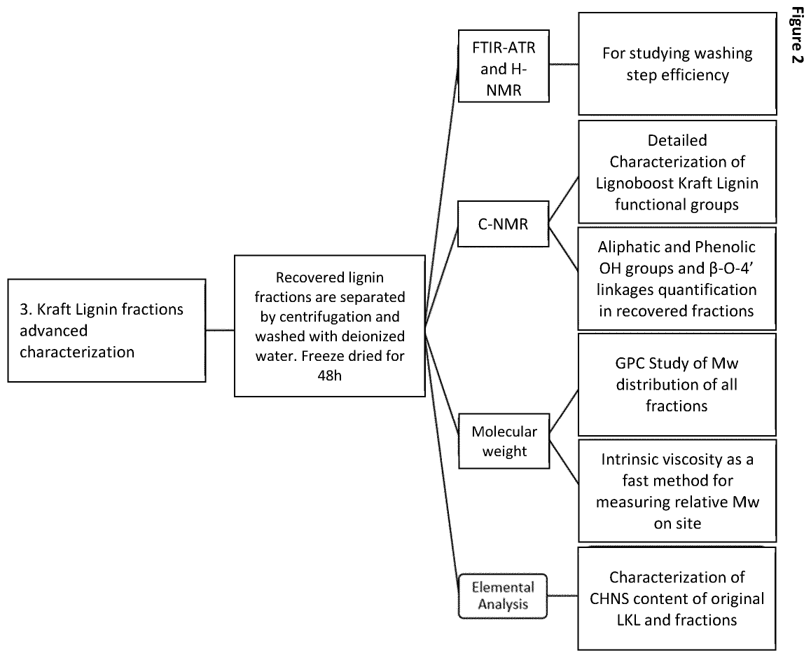

### DETAILED DESCRIPTION

Lignin is a three-dimensional, heterogeneous polymer mainly comprised of three monomeric units, known as p-hydroxyphenyl, guaiacyl and syringyl units. Lignin is divers with respect to e.g. molecular weight, content of phenolic-OH, content of aliphatic OH. Lignin which typically used is used as a starting product in the methods of the present invention refers to Kraft lignin, which is a pure lignin composition.

More generally, the methods used in the present invention are performed on compositions comprising more than 90 wt % lignin, more than 93 wt % lignin or more than 95 wt % lignin.

Such compositions comprises small amounts of cellulose, hemicellulose or ash, typically less than 2.5 wt % cellulose or less than 1 wt % cellulose, less than 10 wt % hemicellulose, less than 5 wt % hemicellulose or less than 2.5 wt % hemicellulose and less than 2.5% ash, less than 1 wt % ash or less than 0.5 wt % ash.

Compositions with any combination of the above values for lignin, cellulose, hemicellulose and ash are herewith explicitly disclosed.

Specific compositions for use as starting material in the methods of the present invention comprise more than 93 wt % lignin, less than 1 wt % cellulose, less than 5 wt % hemicellulose and less than 1 wt % ash.

Kraft lignin is known in the art and is a lignin obtained from the Kraft Process, whereby lignocellulosic material is treated with sodium hydroxide and sodium sulphide. The lignin is then recovered from the black liquor. A more specific type of lignin is obtained via the Lignoboost™ process, wherein The Lignoboost process, uses CO₂ and H₂SO₄ as a method to precipitate and purify lignin from black liquor. This lignin has a low sulfur content (between 1 and 3 wt %) and an ash content between 0.3 and 1.2 wt %.

“Water” used in the methods of the present invention relates to solutions such as drinking water, water from rivers, ground water or wastewater from industrial processes. Water may be the washing water of the methods of the present invention and comprise in specific embodiments minor amounts of hydrotropes (less than 2 wt %).

The examples of the present invention have been performed with dissolution of lignin at room temperature i.e. between 2° and 25° C. Thus the claimed methods can be performed without heating or adding heated water. Thus dependent from the region where the lignin is being treated according to the present invention, steps a) and b) can be performed at temperatures ranging from 10, 20, or 25 degrees up to 30, 35, or 40° C. All ranges with any of the above lower and upper values are considered and herewith explicitly disclosed.

The present invention shows that it is possible to fractionate lignin preparations such as Softwood Lignoboost Kraft lignin (LKL) by using hydrotropic solutions of hydrotropes such as SXS or SCS. Different fractions are obtained by reducing the hydrotrope concentration by dilution with water, thereby decreasing the solubility of lignin. The insoluble lignin fraction is isolated by centrifugation and subsequently washed to remove any residual hydrotrope.

Stepwise dilution allows the fractionation of lignins with different chemical composition.

The characterization of the original lignin as well as the different obtained fractions by FTIR-ATR and H-NMR determined the amount of water necessary to remove all hydrotropic residues from each fraction.

The characterization by GPC, shows that stepwise subsequent precipitation leads to fractions with different Mw and polydispersity. The lower the hydrotropic concentration the lower the polydispersity.

Characterization by quantitative C-NMR showed that different fractions have different contents of chemical groups, with lower Mw fractions having a higher content of phenolic OH groups and a lower content of aliphatic OH groups. Lignin fractions with higher content of phenolic groups are usually associated with more reactive lignin fractions, being more suitable for further chemical or physical modifications in these lignins for future applications. Elemental analysis shows no significant difference between the content of C, H and N of the original lignin and fractions from fractionation with SXS and SCS. The sulphur content is also not significantly different between the starting material and the fractionated lignin, illustrates the fractionation methods of the present invention remove the organically bounded sulphur.

The mass balances show that the 16 wt % of SXS and the 8 wt % of SCS are the fractions with the highest yield, which are also the fractions with higher Mw, 24 and 21 kDa, respectively. While the molecular weight of the 16 wt % SXS fraction is similar to the Mw of the original lignin the polydispersity index is way lower, going from 10.4 to 7.6. The fraction of 10 wt % of SXS only yields about 1% of lignin, however it is the fraction with the lowest molecular weight of about 7 kDa.

Additionally, the recovery of hydrotrope from the washing water and its reutilization for future fractionations is possible decreasing the necessary amount of water to complete different fractionations.

### Example 1

### Dissolution of Kraft Lignin in Hydrotropic Solutions

The behaviour of Lignoboost kraft lignin in hydrotropic solutions was tested by dissolving freeze-dried lignin samples in aqueous solutions of Sodium Xylenesulfonate (SXS), Sodium Cumenesulfonate (SCS)

Regarding the hydrotropic solutions the following procedure was followed:
1. Aqueous solutions of both SXS and SCS with concentrations of 10, 20, 30 and 40 wt % of hydrotrope were prepared in duplicate, by mixing the hydrotrope with deionized water at room temperature.
2. Freeze dried lignin was added to each of the solutions, in a concentration of 25 g/L. Including an additional control solution with only deionized water.
3. One set of solutions was stirred at 25° C. and the other set of solutions was placed in a mixing water bath at 70° C. for 15 min.
4. After the dissolution experiment the solutions were analysed for the presence of undissolved lignin.

### Solubility Limit of Kraft Lignin in Hydrotropic Solutions

After the dissolution of 25 g/L of lignin in hydrotropic solutions, the same experiments were repeated with increased concentration of lignin to verify the solubility limit of lignin in the solutions. For the hydrotropic solutions a 30 wt % of hydrotrope solutions were prepared. The concentration of lignin was tested at 35 g/L, 50 g/L, 100 g/L, 150, g/L, 200 g/L and 250 g/L for both SXS and SCS hydrotropic solutions. A 2 wt % NaOH solution was used for the lignin concentration 50 g/L and 100 g/L.

### Selective Precipitation of Lignin in Hydrotropic Solution

After finding the solubility limits of lignin in both solution types, 6 solutions with a lignin concentration of 100 g/L and an hydrotrope concentration of 30 wt % were prepared and water was added to dilute the concentration of hydrotrope to 20, 10 and 5 wt % to verify the possibility of reprecipitation of lignin in both hydrotropic solutions.

### Fractionation of Kraft Lignin for Valorisation

After confirming the possibility of precipitation of lignin dissolved in hydrotropic solutions, experiments were performed to verify in which range of hydrotropic concentrations it was possible to obtain lignin fractions. New 30 wt % hydrotropic solutions with 100 g/L were prepared for both hydrotropes and were diluted from 20 to 6 wt % decreasing the concentration by 2 wt % based on the previous concentration by addition of deionized water. The precipitate was separated from the remaining hydrotropic solution by centrifugation. This procedure was performed by two different ways. First, by performing direct dilutions from the original 30 wt % hydrotropic concentration to each one of the desired concentrations, from 30 wt % to 16 wt % or from 30 wt % to 10 wt %, etc.

Additionally, the fractionation was performed by a method named “Dilution in Series”, in which the original 30 wt % hydrotropic solution was diluted to 16 wt %, for example, and the precipitate retrieved by centrifugation. Afterwards, the supernatant, with the remaining dissolved lignin, was used for the next dilutions, making it possible to retrieve fractions with a lower polydispersity.

### Advanced Characterization of Lignin Fractions

The recollected fractions were freeze dried for 48 h hours to remove any moisture collected in the precipitate. Regarding the advanced characterization of the fractions different techniques were employed.

### FTIR-ATR Characterization

The collected fractions as well as the original Lignoboost kraft lignin and the pure hydrotropes were analysed by FTIR-ATR to evaluate and compare all chemical structures. The equipment used was a Bruker Alpha. The number of scans was 24 with a resolution of 4 cm⁻¹.

### NMR Characterization

H-NMR and quantitative C-NMR were performed for all the fractions retrieved from SXS and SCS and for the original lignin sample. Regarding the H-NMR analysis spectra were recorded at 25° C. in a Bruker Avance III HD 400, by dissolving around 80 mg of lignin in 0.55 mL of deuterated DMSO.

For quantitative C-NMR a sample preparation procedure based on literature was used [Balakshin et al. (2015) RSC Advances 5, 87187-87199]. Lignin acetylation was performed in all the lignin fractions and original kraft lignin. For this, a mixture of 1:1 (v/v %) of anhydrous pyridine/acetic anhydride, with a total of 4 mL of solution were mixed with 150-200 mg of dried lignin. The solution was stirred for 24 h at room temperature. Afterwards, ethanol was used to remove the pyridine and any traces of acetic anhydride. 10 mL of ethanol were added, and the solution was stirred for an additional 30 min. The ethanol was evaporated, and this procedure was repeated between 7-8 times until the lignin was completely clean and dry. Finally, the samples were washed with water and freeze-dried.

For the C-NMR procedure, 200 mg of acetylated or non-acetylated lignin were mixed with 0.50 ml of deuterated DMSO, 0.06 mL of a relaxation agent solution chromium (III) acetylacetonate (0.016 M), and an internal standard (IS), trioxane (IS: lignin ratio was 1:10, w/w). The final solution was transferred into an NMR tube. A total of 16 samples were analysed by C-NMR. The quantitative C-NMR spectra were recorded at 25° C. in a Bruker Avance 600 MHz. Inverse gate detection and a 90° pulse width were used. A 1.1 s acquisition time and a 2.0 s relaxation delay were used, and 20 000 scans were collected. The spectra were Fourier transformed, phased, calibrated and the baseline was manually corrected by using a polynomial function. The correction of baseline was done using the following approximate interval ranges to be adjusted to zero: (220-215 ppm)-(185-182 ppm)-(97-94 ppm)-(5-(−20) ppm). No other regions were forced to 0. The aromatic region (about 100-163 ppm) in the spectrum was integrated and calibrated to a value of 600. Subsequent integration of the regions of interest in this spectrum are then in the units of “per 100 Ar”.

The calculation of the quantity of specific groups in mmol/g of lignin was calculated based on the following equations:

$$Non - acetylated lignins : X ( mmol {g}^{- 1} lignin ) - {I}_{X} \times \frac{{m}_{IS}}{30 {m}_{lig} \times {I}_{IS}} \times 1000 \qquad Equation 1$$

$$For - acetylated lignins : X ( mmol {g}^{- 1} lignin ) = {I}_{X} \times \frac{{m}_{IS}}{30 {m}_{lig} \times {I}_{IS} - 42 \times {I}_{AC} \times {m}_{IS}} \times 1000 \qquad Equation 2$$

### Where,

X: amount of specific moiety
I_{X}, I_{IS} and I_{Ac}, correspond to the resonance values of the specific moiety, internal standard and total acetylated groups (corresponding to total OH), respectively.
m_{lig} and m_{IS}, are the weights of lignin and internal standard.
   Additionally, 30 is the equivalent mass of the IS (M=90 g/mol) with three equivalent carbons resonating at about 92 ppm) and 42 is the increment in the mass of lignin after acetylation of each OH group.

### Gel Permeation Chromatography

GPC analysis was performed by dissolving the dry lignin samples in DMSO/LiBr (0.5% w/v) after shaking overnight. Prior to GPC analysis, the solutions were filtered through 0.45 μm PTFE syringe filters. The equipment used included an autosampler, column oven, UV detector equipped with a Dionex HPLC Pump Series P580 (Dionex Softron GmbH, Germering, Germany), Dawn HELEOS MALS detectors with a 785 nm laser and a refractive index detector. The MALS detector was equipped with narrow band pass filters. The separation was performed with an Agilent PolarGel M guard column (7.5V50 mm) and three PolarGel M columns 7.5V300 mm (5 mm particle size).

### Elemental Analysis

For the elemental analysis of CHNS, 1-2 mg of dry original lignin and lignin fractions were weighed into a tin capsule along with vanadium (V) oxide for the sulphur analysis. The equipment used was a Flash 2000 elemental analyser.

### Engineering Analysis of Fractionation

For the mass balances, the retrieved lignin fractions were washed with water, and the necessary amount of water was studied by analysing the fractions by FTIR-ATR and H-NMR to guarantee that no residual hydrotrope was found in the fractions. The fractions were freeze-dried for 48 h to remove all moisture and the yield of recovered lignin in each fraction was calculated by the following equation (equation 3):

$$Yield of fraction ( \% ) = \frac{Dry lignin collected from each fraction}{Initial amount of dissolved lignin} \times 100 \qquad Equation 3$$

Regarding the washing water the following procedure was used:
1. The hydrotropic fraction obtained by centrifugation was washed by the addition of deionized water. The fractions were stirred to guarantee that any dissolved hydrotrope in the solid fraction would dissolve in the washing water.
2. The new solution comprising the retrieved fraction and washing water was centrifuged again to separate the washing water from the fraction.
3. The washing water of each fraction, which contains dissolved hydrotrope was saved for recuperation of hydrotrope.

To study the amount of hydrotrope recovered in the washing water, for each fraction, the washing waters were collected separately. Afterwards, a defined amount of washing water was completely evaporated to obtain the final amount of hydrotrope in the washing waters.

Finally, the washing water were concentrated to the initial 30 wt % of hydrotrope.

The final hydrotropic supernatants, 10 wt % in SXS and 6 wt % in SCS were concentrated by evaporation to the initial 30 wt % and mixed with the concentrated washing waters to obtain a hydrotropic solution with the same initial volume as the starting solution.

### Example 2 Dissolution of Kraft Lignin in Hydrotropic Solutions

The dissolution results of 25 g/L of lignin in different concentrations of hydrotropic solutions shows that for hydrotropic concentrations of 10 and 20 wt % (for both hydrotropes) it is not possible to completely dissolve all the lignin, for both experiments at 25 and 70° C. This can be achieved only with the hydrotropic concentrations of 30 and 40 wt %. In the control sample, with just water, no lignin was dissolved.

While the final results were similar at both 25 and 70° C. in terms of the amount of lignin that was undissolved in the bottom of the test tube, the dissolution process was faster in the experiments at 70° C., allowing to reach the total lignin dissolution faster. This phenomenon was observed by a change in the solution colour. While solutions prepared at 25° C. were light brown for a few hours until all the lignin was dissolved and the solutions achieved a dark brown colour, the solutions prepared at 70° C. degrees reached a dark brown colour immediately after the heating procedure for 15 min. As the solubility limit of the hydrotropes solution in water is approximately 40 wt %, this was highest concentration used to avoid precipitation of the hydrotrope. Additionally, as all lignin was dissolved in the 30 wt % hydrotropic solution for a 25 g/L concentration of lignin, this was the hydrotropic concentration chosen for the next experiments. After defining the conditions for the following hydrotropic solutions experiments, the solubility limit of lignin in 30 wt % hydrotropic solution was tested. The results show that it is possible to reach a maximum concentration of lignin for both hydrotropes of 150 g/L of lignin, though these solutions are very viscous and so for the next experiments a concentration of 100 g/L is used.

### Example 3 Selective Precipitation of Lignin in Hydrotropic Solution

To ascertain the possibility of recovering lignin fractions by dilution of the hydrotropic solution to lower concentrations, deionized water was added to 30 wt % hydrotropic solutions with 100 g/L of lignin concentration to 20, 10 and 5 wt %. For both solutions there was no precipitation at 20 wt %, which was not expected since the original dissolution experiments showed undissolved lignin at this hydrotrope concentration. At 10 wt % the sodium xylenesulfonate solution presented a precipitate with a transparent supernatant with a yellow colour. At 5 wt % both hydrotropic solutions produced a supernatant similar to the one from 10 wt %. To understand if between 20 and 5 wt % for the SXS solution and 10 and 5 wt % for the SCS solution it was possible to obtain different lignin fractions another set of experiments were performed.

### Example 4. Fractionation of Kraft Lignin for Valorisation

Starting with the solution of 20 wt % of SXS, different dilutions were performed to verify the possibility of obtaining different fractions, at room temperature. The results for these experiments are presented in Table 1.

TABLE 1
Selective precipitation fractions from SXS
hydrotropic solution.

| Concentration of SXS (wt %) | Precipitation |
|---|---|
| 18 | No |
| 16 | Yes |
| 14 | Yes |
| 12 | Yes |
| 10 | Yes |

While there is no precipitation for the 18 wt % SXS fraction, by diluting the 20 wt % solution to lower concentrations of hydrotrope is possible to retrieve lignin fractions separated of the remaining liquid by centrifugation.

For SCS hydrotropic fractionation experiments, the precipitation was only possible for weight concentrations of 10, 8 and 6 wt %.

### Example 5 Advanced Characterization of Lignin Fractions

### a) FTIR-ATR Analysis

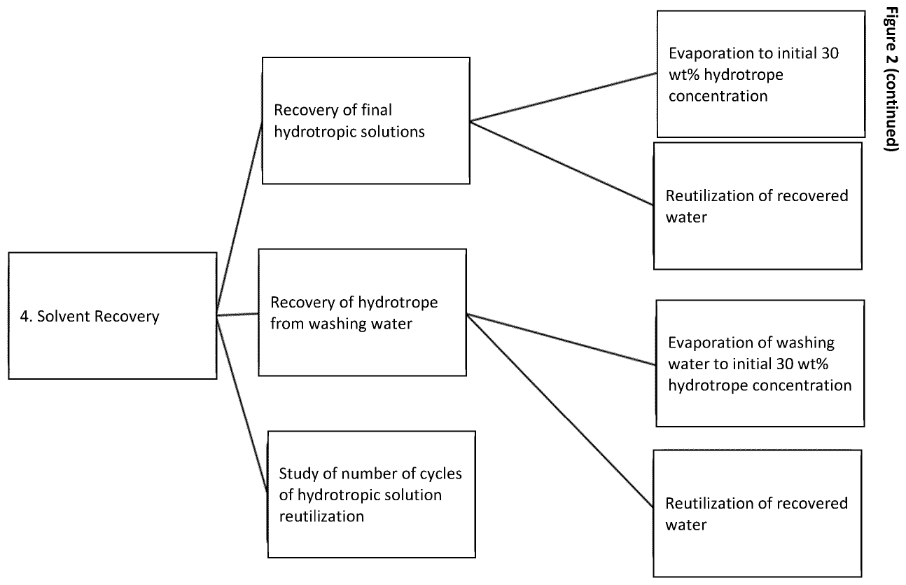

Regarding the advanced characterization of lignin fractions and original lignin sample, the FTIR spectra obtained are shown in FIG. 3 to FIG. 7.

The original lignin spectra peaks were identified by comparing with similar spectra found in literature [Abdelaziz et al. (2017) Waste and Biomass Valorization 8, 859-869; Chen et al. (2016) RSC Advances 6, 107970-107976] and the identification of these peaks are presented in Table 2.

TABLE 2
Band assignment of peaks in original lignin FTIR spectra.

| Observed Peaks | |
|---|---|
| (cm⁻¹) | Band Assignment |
| 3361 | O-H stretching (phenolic-OH and aliphatic OH) |
| 1703 | Non conjugated carbonyl |
| 1598 | Aromatic skeleton (stretching vibration) + C=O stretching |
| 1513 | Aromatic skeleton |
| 1451 | CH₃ + CH₂ (d-asymmetric C-H vibration) |
| 1428 | Aromatic skeleton (C-C vibration) |
| 1368 | Non-etherified phenolic-OH groups |
| 1269 | C-O of Guaiacyl ring (G) (st C-O vibration) |
| 1217 | C-C + C-O stretch/phenolic OH + ether + C-O |
| 1141 | Guaiacyl C-H and syringyl C-H |
| 1031 | Aromatic C-H/1^{st} order aliphatic ether |
| 856 | Guaiacyl units |

To understand how the chemical structures of the recovered lignin fractions were changed by the hydrotropic fractionation these fractions were also freeze dried and analyzed with FTIR.

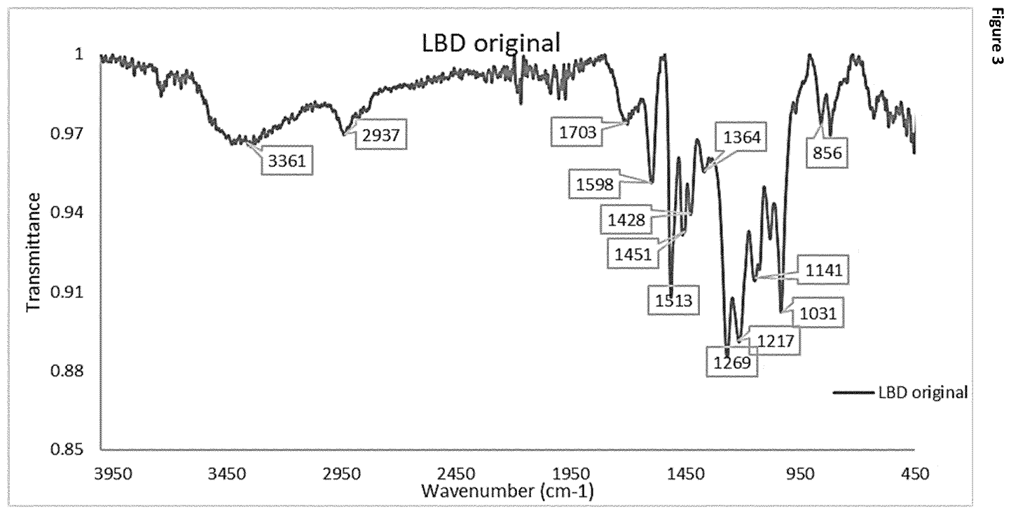

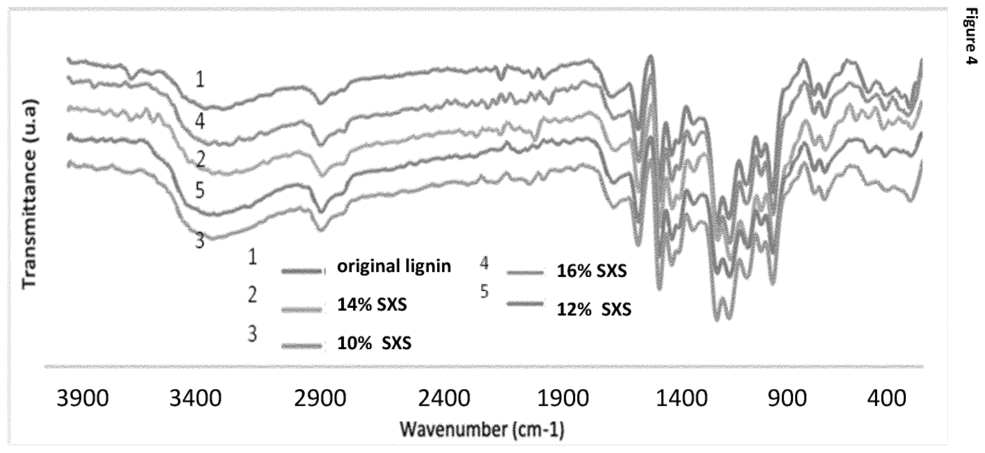

FIG. 4 shows that the spectra obtained for all the fractions are similar, which shows that all the different collected fractions from fractionation with SXS have no significant alterations in their chemical structure. In FIG. 5, the chemical structures for the fractions obtained from the fractionation with SCS are represented.

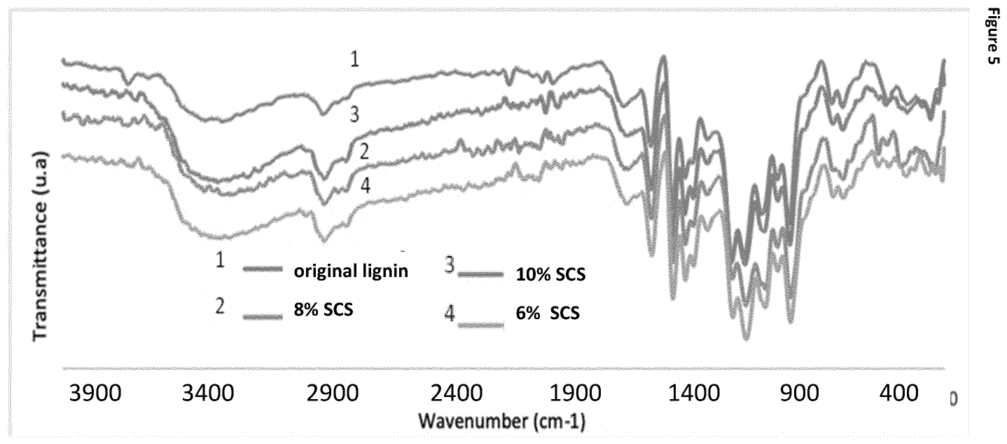

The initial fractions contained residues of hydrotrope, as it can be seen as an example for the 16 wt % SXS fraction in FIG. 6. The amount of necessary water to remove the residual hydrotrope was first analyzed by FTIR and afterwards by H-NMR.

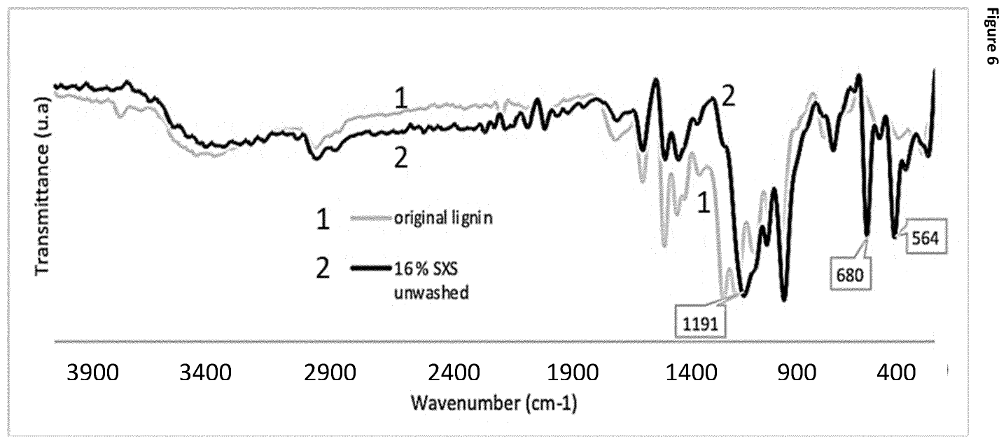

While the spectra of both the lignin fraction and the original lignin show similarities throughout the FTIR spectra (FIG. 6), initially, this was not the case when the fractions were not further washed after precipitation. Certain peaks identified in FIG. 6 showed significant differences. To verify the possibility of vestigial hydrotrope remaining in the precipitate, both hydrotropes were analysed by FTIR and the different peaks compared with the original hydrotrope spectra. After washing several times, the lignin fraction was again freeze dried and analysed with FTIR. The results of the additional washing are presented in FIG. 7.

The FTIR spectra of the 16 wt % rewashed fraction are practically identical to the one of original lignin samples, which indicates that the fractions can be washed from residual hydrotrope and present a chemical structure identical to the pure Lignoboost lignin.

### b) NMR Analysis

Regarding the H-NMR analysis, the most important information provided by this analysis for the lignin samples is the purity of the fractions after washing and removing the residual hydrotrope. While FTIR allows for a quick and direct indication for the presence of residual hydrotrope, H-NMR using a 400 MHZ equipment is a more sensitive technique. For the H-NMR the lignin samples were not acetylated.

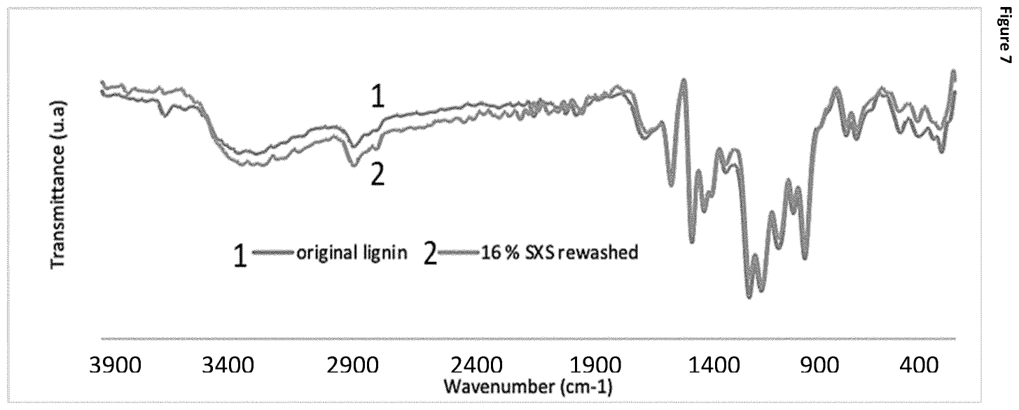

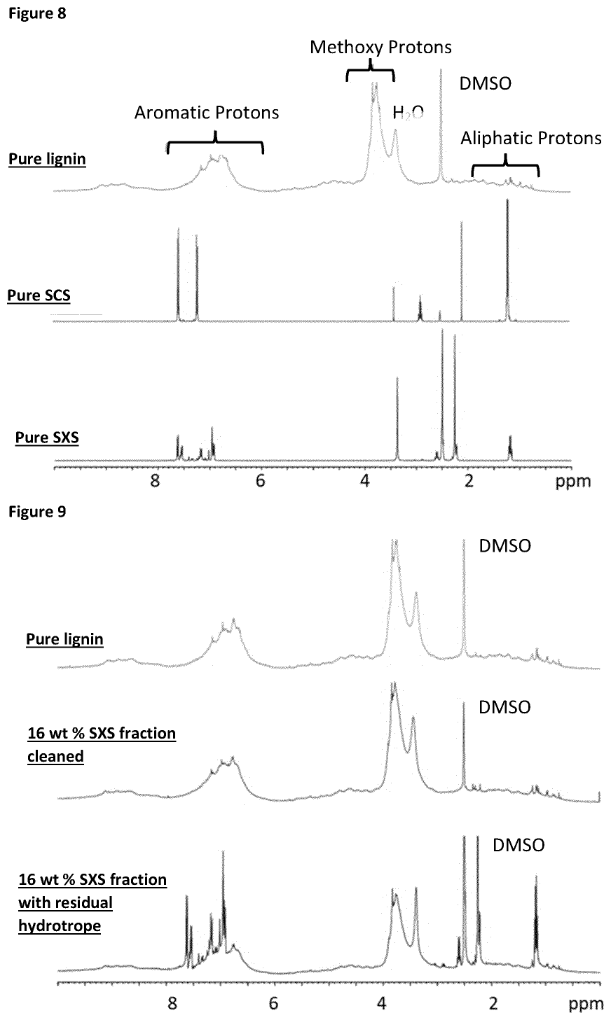

For understanding the differences between the spectra of the initial pure lignin and the samples obtained by fractionation, the spectra of the different fractions were compared with the original lignin sample and with the H-NMR spectra of the pure hydrotropes. FIG. 8, shows the spectra for pure Lignoboost lignin as well as the pure hydrotropes used for the fractionation (SXS and SCS).

The peak identification for the H-NMR was made based on literature [Amadou et al. (2015) BioResources 10, 4933-4946; Shiming & Lundquist. (2007) Nordic Pulp & Paper Research Journal 9, 191-195]

The spectra in FIG. 9 show the difference between the washed spectrum of a 16 wt % SXS fraction and a spectrum of the 16 wt % SXS fraction with residues of hydrotrope, showing that the fractionation does not cause any significant alteration in the lignin structure of the fractions, but the only difference found in the spectra are peaks associated with the hydrotrope residues, when the fractions are not sufficiently washed.

Considering the quantitative C-NMR results, the calculations in mmol/g lignin for the different moieties were made based on literature (Balakshin and Capanema (2015), cited above. Most of the chemical groups' quantifications are based on the values obtained from both the acetylated and non-acetylated spectra of the samples. The following table (Table 3) contains the quantification of the most important moieties for the original LignoBoost lignin as well as the region of the spectra where these moieties are defined. The specific type of Lignoboost sample used, is a softwood that does not contain any S units and only a low percentage of H units.

TABLE 3
Quantification of different moieties of pure Lignoboost sample
based on C-NMR.

| | | Quantification |
|---|---|---|
| | | (mmol/g |
| Structure | Chemical Shift (ppm) | lignin) |
| β-0-4′ | (I_{90-82.5})ₙₐ − (I_{90-82.5})_{ac} | 0.36 |
| % G units | (I₁₁₅₋₁₀₈)_{ac} | 99 |
| % H units | (I₁₆₃₋₁₅₆)ₙₐ | 1 |
| Primary | (I_{171.3-170.2})_{ac} − (I_{171.3-170.2})ₙₐ | 2.6 |
| Aliphatic OH | | |
| Secondary | (I_{170.2-169.4})_{ac} − (I_{170.2-169.4})ₙₐ | 1.5 |
| Aliphatic OH | | |
| Phenolic OH | (I_{169.4-167.5})_{ac} − (I_{169.4-167.5})ₙₐ | 5.1 |
| Non-Conjugated | (I_{178-168.5})ₙₐ | 0.72 |
| COOR | | |
| Conjugated COOR | (I_{168.5-165})ₙₐ | 0.01 |
| Non-Conjugated | ((I₂₁₅₋₂₀₀)_{ac} + (I₂₁₅₋₂₀₀)ₙₐ)/2 | 0.36 |
| CO | | |
| Conjugated CO | ((I₂₀₀₋₁₈₅)_{ac} + (I₂₀₀₋₁₈₅)ₙₐ)/2 | 0.45 |
| OMe | ((I₅₈₋₅₄)_{ac} + (I58-54)na)/2 | 5.2 |
| Ar-H | ((I₁₂₅₋₁₀₂)_{ac} | 13 |
| Degree of | (200 + G %) − (I₁₂₅₋₁₀₂)_{ac} | 70% |
| Condensation | | |

While quantitative C-NMR is one of the most reliable characterization techniques for lignin, the characterization of Kraft Lignin always adds some additional challenges due to modifications that occur in the lignin structure during the kraft process. The main goal of this characterization method when researching lignin fractionation is to evaluate the quantities of Aliphatic OH, Phenolic OH and Carboxyl groups, which are associated with lignin reactivity. Based on literature (Wang, Luyao et al. (2020) ACS Sustainable Chemistry & Engineering 8 (35), 13517-13526), it is expected that lignin fractions with lower Mw have higher content in Phenolic OH and Carboxyl groups and lower content in Aliphatic OH. Additionally, it is expected that lower Mw lignin fractions have a lower content in β-O-4′ linkages, which is the most common linkage between lignin monomeric units. According to literature, a higher phenolic content is associated with a more reactive lignin, which can be an advantage for future applications or chemical modifications.

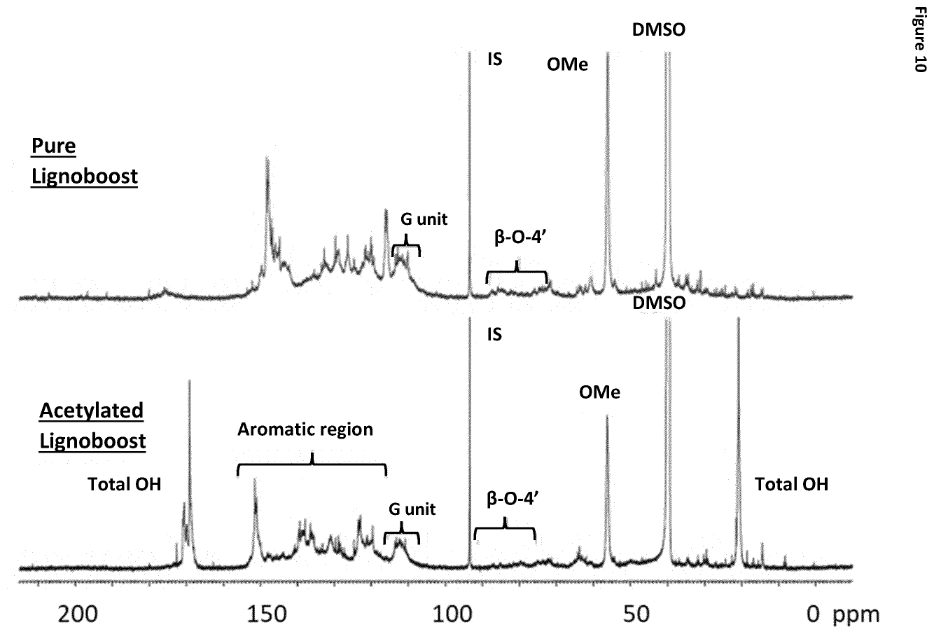

FIG. 10 shows the C-NMR spectra of the acetylated and non-acetylated pure Lignoboost samples, together with the identification in the spectra of some regions of interest. The spectra of the non-acetylated and acetylated lignin fractions obtained from the hydrotropic fractionation are shown in the annexes, with a total of 16 C-NMR spectra collected.

As illustrated in FIG. 10 the acetylation of lignin samples allows the separation of the total OH groups to two different regions in the spectra which makes it possible to quantify this moiety in a more clear way that in the spectrum of non-acetylated lignins.

Table 4 and Table 5 show the phenolic and aliphatic content for the different retrieved lignin fractions and the quantification of the β-O-4′ linkages, respectively.

TABLE 4
Quantification of aliphatic and phenolic OH groups
for the different fractions.

| mmol/g | Aliphatic OH | | Phenolic OH | |
|---|---|---|---|---|
| lignin | pure lignin | 4.1 | pure lignin | 5.1 |
| SXS fractions | 16% | 3.1 | 16% | 5.3 |
| (wt %) | 14% | 3.2 | 14% | 5.7 |
| | 12% | 3.2 | 12% | 5.8 |
| | 10% | 2.9 | 10% | 6.1 |
| SCS fractions | 10% | 4.0 | 10% | 5.0 |
| (wt %) | 8% | 3.7 | 8% | 5.2 |
| | 6% | 3.6 | 6% | 5.5 |

TABLE 5
Quantification of β-O-4′ linkages in the different fractions.

| Fraction | | mmol/g lignin |
|---|---|---|
| pure lignin | | 0.36 |
| SXS (wt %) | 16% | 0.38 |
| | 14% | 0.33 |
| | 12% | 0.23 |
| | 10% | 0.21 |
| SCS (wt %) | 10% | 0.35 |
| | 8% | 0.30 |
| | 6% | 0.28 |

As shown in Table 4 and Table 5, the different obtained fractions have different quantities of aliphatic and phenolic OH as well as β-O-4′ linkages. The trend of higher contents of phenolic OH and lower of aliphatic OH with the decrease of the Mw, is proved in the section dedicated to the GPC results.

### c) Gel Permeation Chromatography (GPC)

The Mw and Polydispersity of the different fractions and the original Lignoboost lignin were measured by a specific GPC technique. Technical lignins, particularly Kraft Lignin sample are known to fluoresce after absorption of UV radiation, which can influence the results obtained by standard GPC systems by giving higher or lower Mw, instead of the correct values. In this analysis, a system with fluorescence filters was used on the MALS detector connected to the GPC device to avoid interferences in the Mw from this phenomenon. From this technique it is possible to obtain several parameters to describe the molecular weight distribution of a polymer such as the number average molecular weight (Mn), molecular weight of the highest peak (Mp), higher average molecular weight (Mz), weight average molecular weight (Mw) and polydispersity index (Mw/Mn).

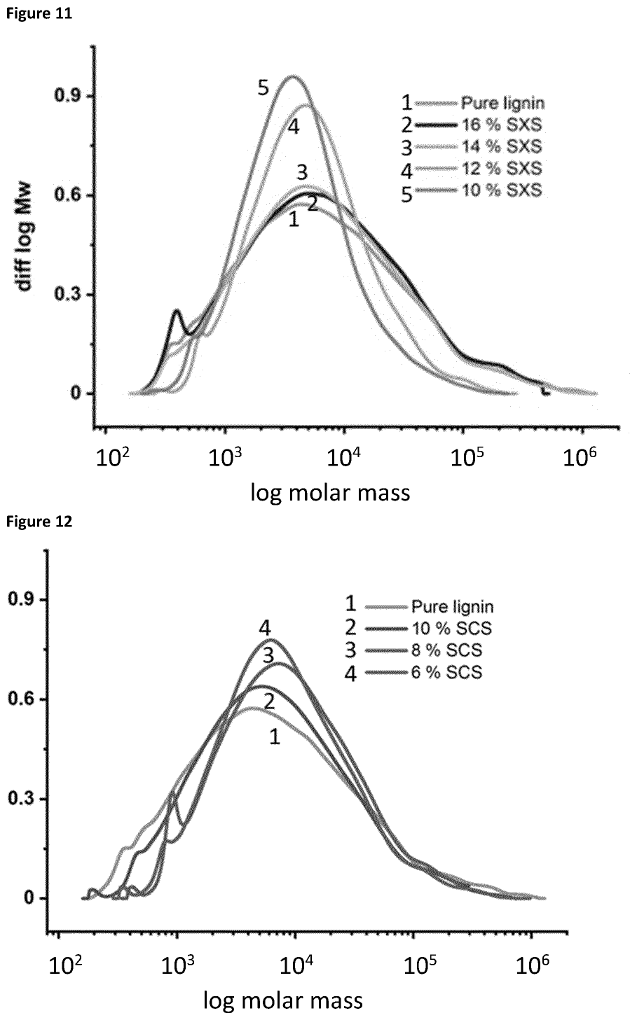

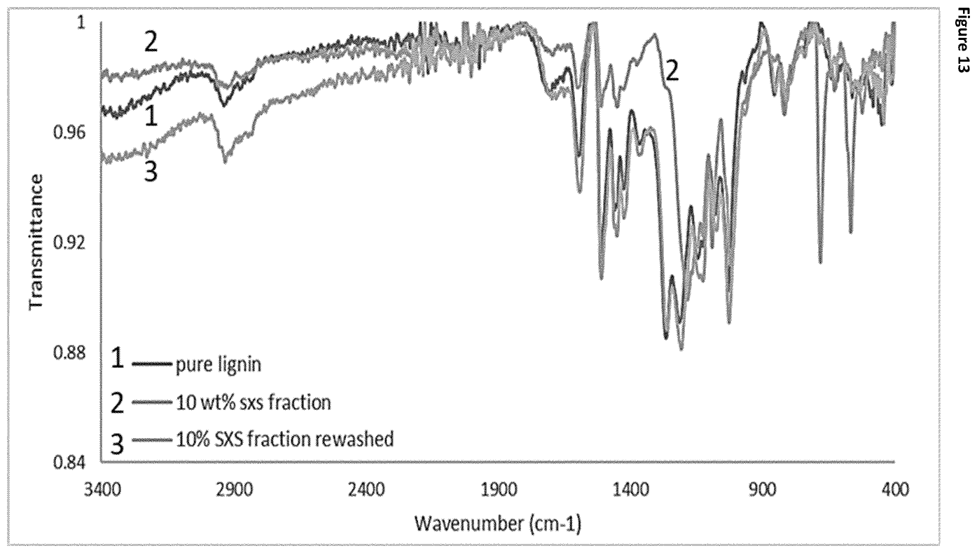

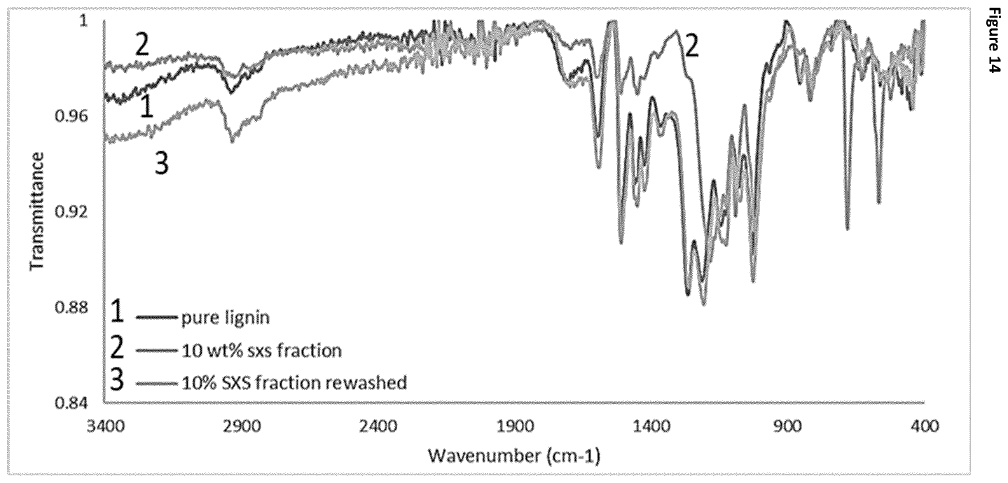

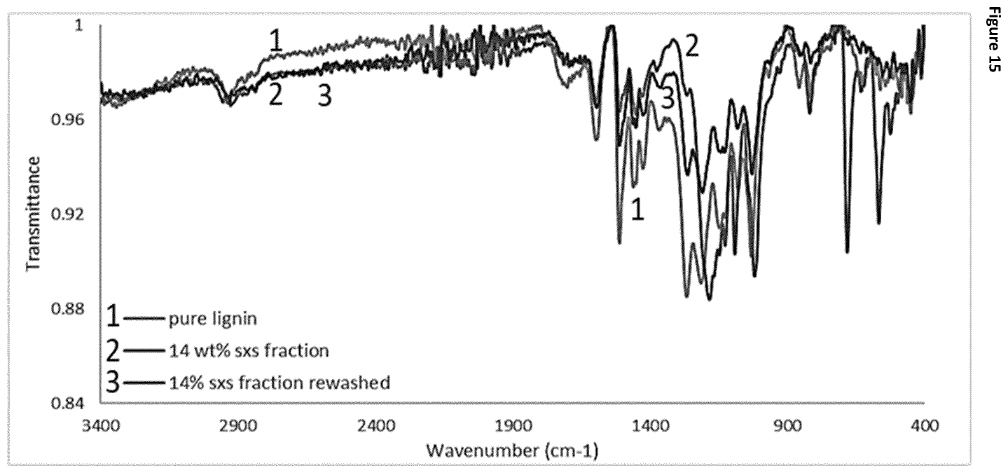

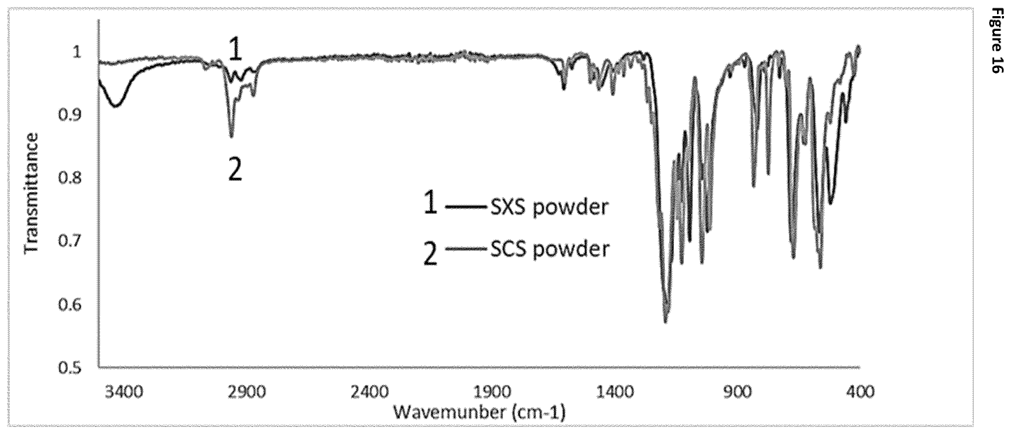

Table 6 and 7 show the results of the GPC analysis for the fractions obtained from the fractionation of kraft lignin using SXS and SCS, respectively, Additionally, FIG. 11 and FIG. 12 show the graphs of molecular weight distribution for the fractions obtained by using both hydrotropes.

TABLE 6
GPC results for different fractions obtained
by fractionation with SXS.

| Lignin | GPC data | | | | |
|---|---|---|---|---|---|
| samples | Mn (kDa) | Mp (kDa) | Mw (kDa) | Mz (kDa) | Mw/Mn |
| Pure Lignin | 2.3 | 4.3 | 24.5 | 215 | 10.4 |
| 16 wt % SXS | 3.2 | 6.6 | 24.6 | 130 | 7.6 |
| 14 wt % SXS | 2.6 | 4.7 | 20.6 | 151 | 7.9 |
| 12 wt % SXS | 3.0 | 4.8 | 9.7 | 35 | 3.2 |
| 10 wt % SXS | 2.4 | 3.7 | 7.3 | 28 | 3.0 |

TABLE 7
GPC results for different fractions obtained
by fractionation with SCS.

| Lignin | GPC data | | | | |
|---|---|---|---|---|---|
| samples | Mn (kDa) | Mp (kDa) | Mw (kDa) | Mz (kDa) | Mw/Mn |
| Pure Lignin | 2.3 | 4.3 | 24.5 | 215 | 10.4 |
| 10 wt % SCS | 2.8 | 5.3 | 24.0 | 284 | 8.4 |
| 8 wt % SCS | 4.2 | 7.3 | 21.3 | 110 | 5.0 |
| 6 wt % SCS | 4.1 | 6.2 | 19.0 | 108 | 4.6 |

The examples demonstrate that the fractionation of the Lignoboost Lignin with hydrotropes SXS and SCS is possible, whereby the lower the hydrotrope concentration, the lower the Mw of the fraction. Moreover, the polydispersity also decreases with decreasing the hydrotrope concentration. When comparing the GPC results with the C-NMR results, it is shown that, as expected, the lower Mw fractions have a higher phenolic OH and a lower aliphatic OH content.

### d) Intrinsic Viscosity and Molecular Weight

The relative molecular weight of the fractions was measured through an indirect method that relates intrinsic viscosity of a solution with its MW. The Mark-Houwink-Sakurada constants used for the calculations were 0.4165 and 0.23 for K and α, respectively. The lignin fractions were dissolved in a 2 wt % NaOH solution and the viscosity was measured at 30° C. The results are shown in Table 8 and Table 9.

TABLE 8
Intrinsic viscosity and relative molecular weight
of lignin SXS fractions.

| | Intrinsic | Relative |
|---|---|---|
| | viscosity | Molecular |
| Fraction | (mL/g) | Weight (kDa) |
| Pure lignin | 4.4480 | 28.5 |
| 16 wt % SXS | 4.2649 | 25 |
| 14 wt % SXS | 3.9768 | 18 |
| 12 wt % SXS | 3.3501 | 9 |
| 10 wt % SXS | 3.1540 | 7 |

TABLE 9
Intrinsic viscosity and relative molecular
weight of lignin SCS fractions.

| | | Relative |
|---|---|---|
| | Intrinsic | Molecular |
| | viscosity | Weight |
| Fraction | (mL/g) | (kDa) |
| Pure lignin | 4.4480 | 28.5 |
| 10 wt % SCS | 4.3531 | 27 |
| 8 wt % SCS | 4.2456 | 24 |
| 6 wt % SCS | 3.7698 | 12 |

While the results for the Mw of the fractions are not the exact molecular weight, since this is not an absolute method for measuring the Mw, it is still possible to see that the fractions have different relative molecular weights, confirming the hypothesis of fractionation of kraft Lignoboost lignin by selective precipitation with hydrotropic solutions. Additionally, this method can be used to have an idea of the Mw of the fractions during the process, in laboratories and pilot plants where a GPC equipment is not available.

### Elemental Analysis

The results for the elemental analysis are presented In table 10 and 11.

TABLE 10
Elemental analysis results for SXS fractions.

| | | Run | 1 Run | 2 Run | | |
|---|---|---|---|---|---|---|
| Sample | | (%) | (%) | (%) | 3 x̅ (%) | s (%) |
| Original | C | 64.20 | 64.19 | 63.90 | 64.10 | 0.17 |
| Lignoboost | H | 5.63 | 5.69 | 5.72 | 5.68 | 0.04 |
| Lignin | N | 0.24 | 0.23 | 0.26 | 0.24 | 0.02 |
| | S | 1.97 | 1.97 | 1.97 | 1.97 | 0 |
| 16 wt % SXS | C | 63.97 | 63.98 | 63.93 | 63.94 | 0.04 |
| | H | 5.75 | 5.73 | 5.74 | 5.75 | 0.02 |
| | N | 0.26 | 0.25 | 0.25 | 0.25 | 0.01 |
| | S | 2.07 | 2.03 | 2.04 | 2.04 | 0.02 |
| 14 wt % SXS | C | 65.78 | 65.74 | 65.66 | 65.73 | 0.06 |
| | H | 5.75 | 5.77 | 5.84 | 5.79 | 0.04 |
| | N | 0.27 | 0.24 | 0.26 | 0.26 | 0.01 |
| | S | 1.67 | 1.70 | 1.68 | 1.69 | 0.02 |
| 12 wt % SXS | C | 65.28 | 65.23 | 65.07 | 65.19 | 0.11 |
| | H | 5.75 | 5.82 | 5.75 | 5.78 | 0.04 |
| | N | 0.24 | 0.26 | 0.24 | 0.25 | 0.01 |
| | S | 1.66 | 1.66 | 1.66 | 1.66 | 0 |
| 10 wt % SXS | C | 65.80 | 65.53 | 65.56 | 65.63 | 0.15 |
| | H | 5.78 | 5.81 | 5.83 | 5.81 | 0.02 |
| | N | 0.26 | 0.26 | 0.25 | 0.26 | 0.01 |
| | S | 1.65 | 1.64 | 1.65 | 1.65 | 0.01 |

Table 10 shows the elemental analysis of the pure Lignoboost lignin and the fractions obtained by fractionation with SXS. The results show that for C, H and N there is no significant difference between the original sample and the fractions of SXS. Regarding the sulphur content, only the fraction of 16 wt % SXS shows a higher content than the original lignin. However, this additional amount of sulphur should not come from residual hydrotrope in the sample, as an NMR analysis was performed beforehand to guarantee that no residual hydrotrope was in the samples prior to the elemental analysis. The lower contents of sulphur in the 14, 12 and 10 wt % SXS fractions than in the original lignin can be caused by extensive washing of the fractions thereby removing elemental and inorganic sulphur, leaving only the organically bounded sulphur.

TABLE 11
Elemental analysis results for SCS fractions.

| | | Run | 1 Run | 2 Run | | |
|---|---|---|---|---|---|---|
| Sample | | (%) | (%) | (%) | 3 x̅ (%) | s (%) |
| Original | C | 64.20 | 64.19 | 63.90 | 64.10 | 0.17 |
| Lignoboost | H | 5.63 | 5.69 | 5.72 | 5.68 | 0.04 |
| Lignin | N | 0.24 | 0.23 | 0.26 | 0.24 | 0.02 |
| | S | 1.97 | 1.97 | 1.97 | 1.97 | 0 |
| 10 wt % SCS | C | 64.81 | 64.74 | 64.85 | 64.80 | 0.06 |
| | H | 5.81 | 5.82 | 5.85 | 5.82 | 0.01 |
| | N | 0.23 | 0.24 | 0.25 | 0.24 | 0.01 |
| | S | 2.23 | 2.23 | 2.26 | 2.24 | 0.02 |
| 8 wt % SCS | C | 65.26 | 65.16 | 65.42 | 65.28 | 0.13 |
| | H | 5.87 | 5.87 | 5.88 | 5.87 | 0 |
| | N | 0.26 | 0.22 | 0.26 | 0.25 | 0.02 |
| | S | 2.12 | 2.20 | 2.13 | 2.15 | 0.04 |
| 6 wt % SCS | C | 65.23 | 65.46 | 65.34 | 65.34 | 0.12 |
| | H | 5.84 | 5.88 | 5.85 | 5.85 | 0.01 |
| | N | 0.24 | 0.24 | 0.23 | 0.24 | 0.01 |
| | S | 1.78 | 1.79 | 1.79 | 1.79 | 0.01 |

The data in table 11 also show that for the C, H and N content there is also no significant differences between the original lignin and the fractions. However, the fraction of 10 and 8 wt % SCS have a higher content in sulphur than the original lignin, which can indicate that these samples have a higher sulphur content than the fraction with lower Mw, the 6 wt % fraction.

### Example 6 Engineering Analysis of Fractionation Mass Balances

For the determination of mass balances, all retrieved fractions were washed and freeze dried. The yield of each fraction was then calculated based on the initial amount of lignin in the initial hydrotropic solutions. Table 12 and Table 13, show the yields for the different fractions obtained from the SXS and SCS experiments.

TABLE 12
Yield of fractions from fractionation with SXS.

| Fraction | Yield % |
|---|---|
| 16 wt % SXS | 71.8-72.5% |
| 14 wt % SXS | 10.6-11% |
| 12 wt % SXS | 2.2-2.8% |
| 10 wt % SXS | 0.8-1.4% |

TABLE 13
Yield of fractions from fractionation with SCS.

| Fraction | Yield % |
|---|---|
| 10 wt % SCS | 4.4-5.8% |
| 8 wt % SCS | 78-79.7% |
| 6 wt % SCS | 4.8-5.5% |

Between 10 and 13% of the original lignin remains dissolved in the final supernatant. While it is possible to retrieve this remaining dissolved lignin, it would be necessary to decrease the hydrotropic concentration to values of 2 wt %, since in the concentrations bellow 10 wt % SXS and 6 wt % SCS there is no precipitation of a fraction. The amount of water necessary to reach the 2 wt % hydrotrope does not compensate for the lignin retrieved. After the recovery of the final fraction, for both SXS and SCS, the dissolved lignin can be recovered using a filter, membrane or centrifugation, and the remaining hydrotropic solution can be concentrated to 30 wt % and reused in a new fractionation cycle.

To completely remove the residual hydrotrope from the different lignin fractions, the ratio of water per gram of dry lignin necessary, is around 200 parts weight of water to 1 part weight of dry lignin. While this is a substantial amount of water, this water can be reutilized.

For each fraction, after the centrifugation step, the concentration of hydrotrope that remains in the wet lignin fraction (precipitate) and supernatant are similar, which means that the hydrotrope present in the fractions is removed with water and is retained in this washing water.

To reuse the hydrotrope dissolved in the washing water for future fractionations, the washing water solution is concentrated by evaporation to the initial 30 wt % hydrotropic concentration, and the condensation water can be reused for future dilutions and washing step. This means that while a considerable amount of water is necessary for the first fractionation, this water can be recovered and reused making the process water efficient and decreasing the costs associated with this utility.

Additionally, each precipitated fraction, after washing contains about 7.5% solid lignin. The remaining of each fraction is water, which is at the present removed by lyophilization.

### Solvent Recovery and Reutilization

The solvent recovery and reutilization are still under investigation. While it was already possible to recover the final hydrotropic solutions, which correspond to the supernatant of the 10 wt % fraction in SXS and 6 wt % fraction in SCS, the exact number of times that these solutions can be reused to produce the same fractions without losing its hydrotropic power is still being studied.

Moreover, the water recovered from the evaporation step necessary to concentrate the diluted supernatant and washing water to the initial 30 wt % hydrotropic concentrations can be reused for future dilutions and washing steps, decreasing the future costs with this utility and providing a more environmentally friendly process.

### Example 7 FTIR-ATR Characterization

In the FTIR-ATR characterization, all the spectra from the different obtained fractions was compared with the original lignin. The following figures show the comparison of spectra between the original lignin and the fractions before and after additional washing.

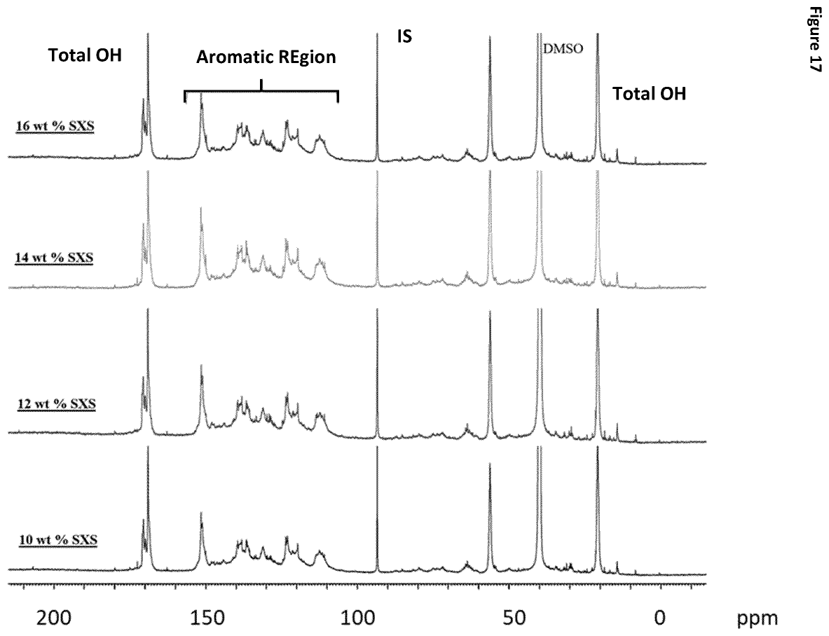

The FTIR-ATR spectra of both hydrotropes used for the fractionation are shown in FIG. 16.

### Example 8 Quantitative C-NMR Additional Spectra

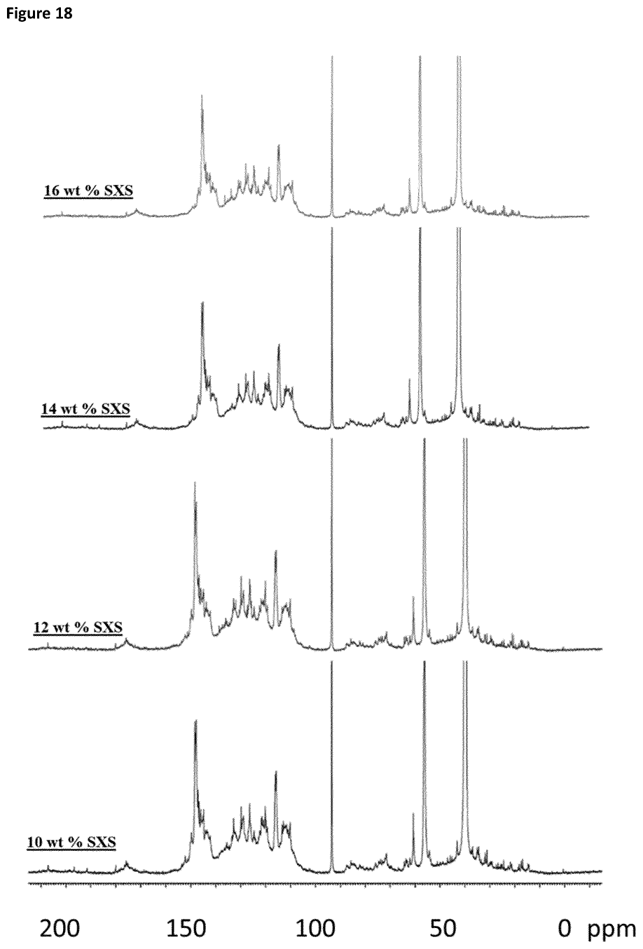

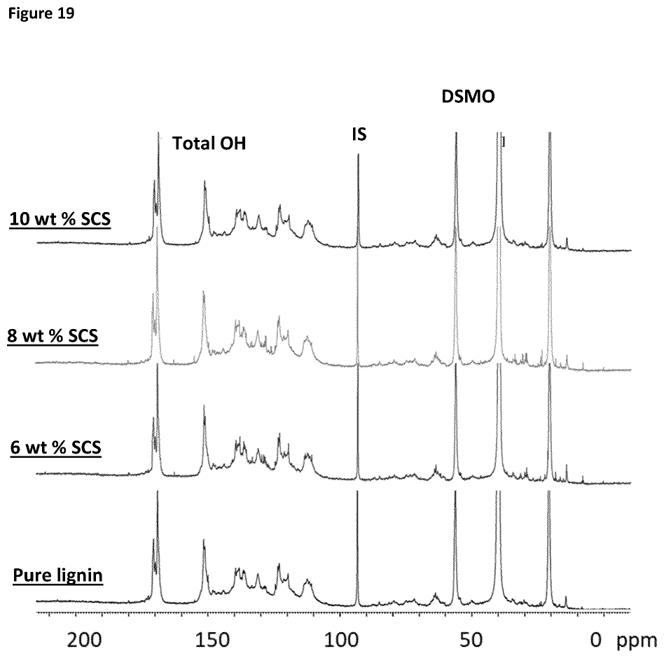

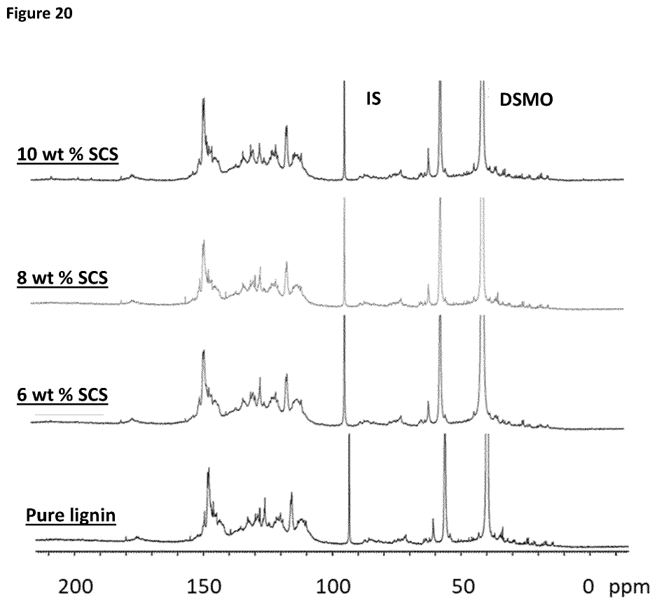

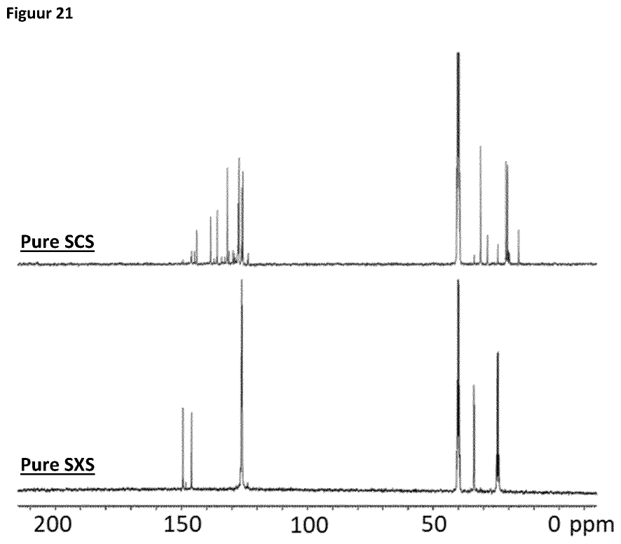

The following figures, FIG. 17 to FIG. 20 show the C-NMR spectra of the acetylated and non-acetylated samples of the different fractions obtained through the fractionation of kraft lignin using SXS and SCS. As explained before, the difference between the spectra of the acetylated and non-acetylated samples is that the OH groups in lignins are changed by acetyl groups, which appear in a different region of the C-NMR spectra and makes it easier to quantify the aliphatic and phenolic OH groups.

The spectra of the fractions obtained from fractionation with SXS and SCS are mostly equal to the spectra of pure lignin in terms of chemical structure, and the main difference is just seen when the integration of the peaks and consequent calculations of the moieties in mmol/g Lignin is made. All the peak integration and calculations were performed using TopSpin software.

Additionally, the C-NMR spectra of pure SXS and pure SCS was recorded to understand if there were hydrotrope impurities in the spectra of the retrieved fractions. These spectra are shown in FIG. 21.

1. A method of obtaining from a solution comprising solubilised lignin, a fraction of lignin which is enriched in aliphatic OH content, in phenolic OH content, or in a molecular weight range, the method comprising the steps of:
a) adding water to a solution comprising solubilised lignin and a hydrotrope, thereby lowering the hydrotrope concentration, until a part of the lignin becomes insoluble, and
b) isolating the insoluble lignin,
repeating steps a) and b) one or more times wherein the hydrotrope concentration is further lowered by the addition of water.

2. The method according to claim 1, wherein the solubilised lignin comprises more than 93 wt % lignin.

3. The method according to claim 1, wherein the solubilised lignin is kraft lignin.

4. The method according to claim 1, wherein steps a) are performed at a temperature below 40° C.

5. The method according to claim 1, wherein the solution comprising solubilised lignin and a hydrotrope has a concentration of between 25, or 50 up to 100 or 120 g lignin/litre.

6. The method according to claim 1, wherein the solution comprising solubilised lignin and a hydrotrope has a concentration of 30 wt % hydrotrope.

7. The method according to claim 1, wherein the hydrotrope is SXS or SCS.

8. The method according to claim 1, wherein the hydrotrope is SXS and wherein the concentration of SXS is stepwise or continuously decreased to down 10 wt % SXS.

9. The method according to claim 1, wherein the hydrotrope is SCS and wherein the concentration of SCS is decreased stepwise or continuously down to 6 wt % SCS, typically stepwise decreased.

10. The method according to claim 1, wherein the initial solution comprising solubilised lignin and a hydrotrope is diluted with water to between a threefold and a fivefold.

11. Use of the method according to claim 1, for enriching from a crude fraction of lignin, a fraction of lignin which is enriched in aliphatic OH content, in phenolic OH content, or in a molecular weight range.
